(19) United States
(12) Patent Application Publication
(10) Pub. No.: US 2018/0201218 A1
(43) Pub. Date: Jul. 19, 2018

(54) VEHICLE INTERIOR COMPONENT

(71) Applicant: Shanghai Yanfeng Jinqiao Automotive Trim Systems Co. Ltd., Novi, MI (US)

(72) Inventors: Guangwei Zhang, Shanghai (CN); Jianfeng Hou, Shanghai (CN); Xueyong Zhang, Shanghai (CN); Lan Zhao, Shanghai (CN); Jianyi Zheng, Shanghai (CN); Guirong Zhou, Shanghai (CN); Wei Wang, Shanghai (CN)

(21) Appl. No.: 15/922,761

(22) Filed: Mar. 15, 2018

Related U.S. Application Data
(63) Continuation-in-part of application No. PCT/CN2016/099001, filed on Sep. 14, 2016.

(30) Foreign Application Priority Data
Sep. 16, 2015 (CN) 201510589804.4
Sep. 16, 2015 (CN) 201520717428.8

(51) Int. Cl. B60R 21/2165; B60R 21/205; B60R 13/02; B29C 45/16; B29C 45/14

(52) U.S. Cl. CPC B60R 21/2165; B60R 21/205; B60R 13/0256; B29L 2031/3038; B29C 45/1635; B29C 45/14311; B29C 45/1657; B29C 45/1671

(57) ABSTRACT

A trim component for a vehicle interior configured to provide an opening for deployment of an airbag is disclosed. The component may comprise a weakened substrate and insert to direct deployment of the airbag. The insert may comprise a film formed from a polypropylene composition and may be secured between an airbag chute and the substrate. The film may be bonded to the substrate. The chute may be welded to the film and the substrate. The polypropylene composition may comprise polypropylene, an elastomer and polyethylene. The chute may be formed from a thermoplastic polyolefin material. A weakened portion of the insert and a weakened portion of the substrate may be formed concurrently. Thermoplastic polypropylene material may be injected into a mold at a temperature to form the substrate and melt the film in order to bond the film to the substrate.

### CROSS REFERENCE TO RELATED APPLICATIONS

The present application is a continuation-in-part of International/PCT Patent Application No. PCT/CN2016/099001 titled “INSTRUMENT PANEL COMPONENT AND METHOD OF FORMING” filed Sep. 14, 2016, which claims the benefit of Chinese Utility Patent Application No. 201510589804.4 titled “INSTRUMENT PANEL COMPONENT AND METHOD OF FORMING” filed Sep. 16, 2015 and Chinese Utility Model Application No. 201520717428.8 titled “INSTRUMENT PANEL COMPONENT AND METHOD OF FORMING” filed Sep. 16, 2015.

The present application claims priority to and incorporates by reference in full the following applications: (a) Chinese Utility Patent Application No. 201510589804.4 titled “INSTRUMENT PANEL COMPONENT AND METHOD OF FORMING” filed Sep. 16, 2015; (b) Chinese Utility Model Application No. 201520717428.8 titled “INSTRUMENT PANEL COMPONENT AND METHOD OF FORMING” filed Sep. 16, 2015; (c) International/PCT Patent Application No. PCT/CN2016/099001 titled “INSTRUMENT PANEL COMPONENT AND METHOD OF FORMING” filed Sep. 14, 2016.

### FIELD

The present invention relates to a trim component for a vehicle interior configured to provide an opening for deployment of an airbag through the opening. The present invention also relates to a trim component for a vehicle interior configured to provide an opening for deployment of an airbag through the opening prepared by a process. The present invention also relates to a method for forming a trim component in a mold.

### BACKGROUND

It is well-known to provide a trim component for a vehicle interior configured to provide an opening for deployment of an airbag through the opening.

It would be advantageous to provide an improved a trim component for a vehicle interior configured to provide an opening for deployment of an airbag through the opening.

### SUMMARY

The present invention relates to a trim component for a vehicle interior configured to provide an opening for deployment of an airbag through the opening. The component may comprise a substrate comprising a weakened portion configured to direct deployment of the airbag, an insert coupled to the substrate comprising a weakened portion configured to direct deployment of the airbag and a chute coupled to the substrate and the insert. The insert may comprise a film comprising a polypropylene composition. The film may be secured between the chute and the substrate. The film is bonded to the substrate. The chute may be welded to the film and the substrate. The weakened portion of the insert may extend from the weakened portion of the substrate. The substrate may be formed from a thermoplastic polypropylene material. The polypropylene composition may comprise polypropylene; an elastomer; and polyethylene. The chute may be formed from a thermoplastic polyolefin material. The weakened portion of the insert and the weakened portion of the substrate may be formed concurrently. The film may comprise a thickness of less than 1.0 mm.

The present invention also relates to a trim component for a vehicle interior configured to provide an opening for deployment of an airbag through the opening prepared by a process comprising the steps of: placing a film in the mold; closing the mold; injecting thermoplastic polypropylene material into the mold to form a substrate with the film; opening the mold and removing the substrate with the film; weakening the substrate and the film to define an airbag door opening; and attaching a chute to the film and the substrate to form the trim component

The present invention further relates to a method for forming a trim component in a mold comprising the following steps: placing a film in the mold; closing the mold; injecting thermoplastic polypropylene material into the mold to form a substrate with the film; opening the mold and removing the substrate with the film; weakening the substrate and the film to define an airbag door opening; and attaching a chute to the film and the substrate to form the trim component. The thermoplastic polypropylene material may be injected into the mold at a temperature to melt the film in order to bond the film to the substrate. The chute may be attached to the film and the substrate by welding the chute to the film and the substrate. The film may be formed from a polypropylene composition. The polypropylene composition may comprise polypropylene; an elastomer and polyethylene. The elastomer may comprise at least one of (a) ethylene-hexene copolymer; (b) ethylene-butene copolymer; (c) ethylene-octene copolymer. The polyethylene may comprise a density of 0.94 g/cm3 to 0.97 g/cm3. The polyethylene may comprise an antioxidant and a lubricant. The antioxidant may comprise a compound of hindered phenolic antioxidant and phosphite antioxidant. The lubricant may comprise at least one of polyethylene wax and oxidized polyethylene wax. The polypropylene composition may comprise 45 to 75 percent polypropylene; 10 to 35 percent elastomer; and 5 to 20 percent polyethylene. The polypropylene composition may comprise a homo-polypropylene with an isotactic index of 94 percent to 98 percent.

### FIGURES

FIG. 1 is a schematic perspective view of a vehicle according to an exemplary embodiment.

FIG. 1B is a schematic perspective view of a vehicle interior according to an exemplary embodiment.

FIG. 1C is a schematic perspective view of an instrument panel for vehicle interior according to an exemplary embodiment.

FIG. 2A is a schematic perspective view of an instrument panel for vehicle interior according to an exemplary embodiment.

FIGS. 2B to 2D are schematic perspective views of airbag deployment according to an exemplary embodiment.

FIG. 2E is a schematic perspective view of airbag deployment from a conventional instrument panel according to an exemplary embodiment.

FIG. 3A is a schematic section view of a vehicle trim component according to an exemplary embodiment.

FIGS. 3B to 3D are partial schematic section views of a vehicle trim component according to an exemplary embodiment.

FIG. 4A to 4C are partial schematic section views of airbag deployment from a vehicle trim component according to an exemplary embodiment.

FIGS. 5A to 5C are partial schematic section views of airbag deployment from a conventional vehicle trim component according to an exemplary embodiment.

### DESCRIPTION

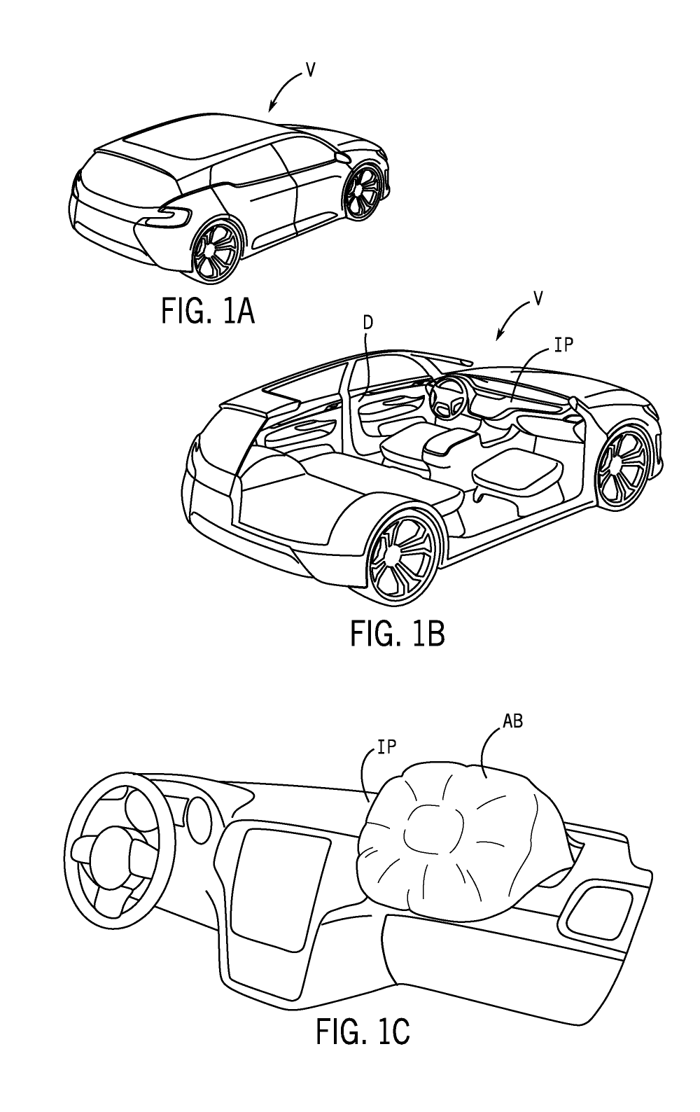

According to an exemplary embodiment as shown schematically in FIGS. 1A to 1B, a vehicle V is shown including an interior with a door D and an instrument panel IP.

According to an exemplary embodiment as shown schematically in FIG. 1C, instrument panel IP may provide an opening for deployment of an airbag AB.

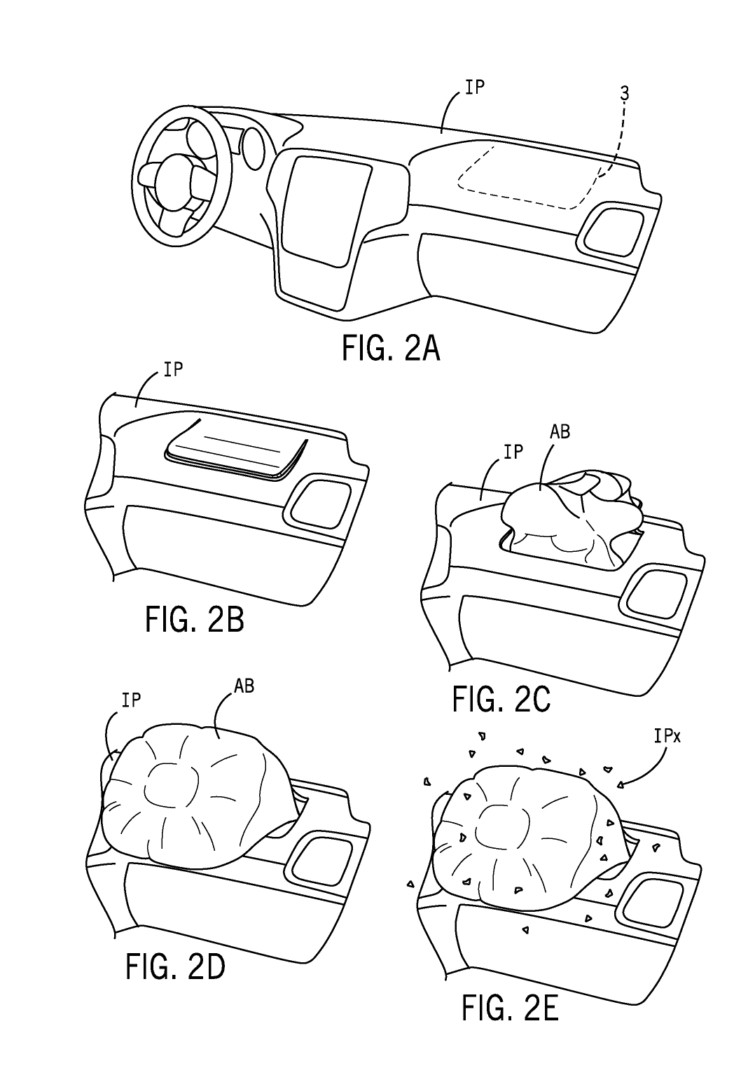

According to an exemplary embodiment as shown schematically in FIGS. 2A to 2D, instrument panel IP may include a weakened portion 3 to provide an opening for deployment of an airbag AB.

According to an exemplary embodiment as shown schematically in FIG. 2E, portions IPx of a conventional instrument panel may be formed upon deployment of an airbag from a conventional instrument panel.

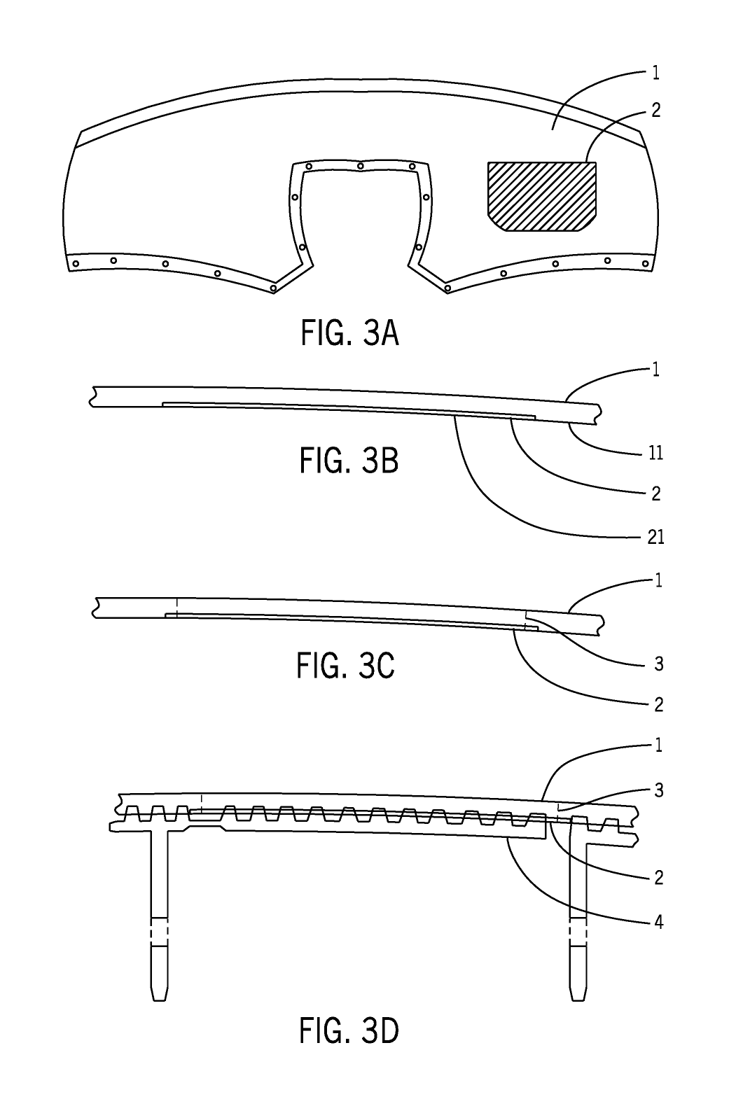

According to an exemplary embodiment, a trim component for a vehicle interior may comprise a substrate or instrument panel body 1 and an insert or film 2 coupled to substrate 1 as shown schematically in FIG. 3A. Substrate 1 may be formed from a thermoplastic polypropylene material. Insert 2 may be bonded to substrate 1. Insert 2 may comprise a thickness of less than 1.0 mm. Insert 2 may comprise a film comprising a polypropylene composition. The polypropylene composition may comprise polypropylene; an elastomer; and polyethylene. The polypropylene composition may comprise 45 to 75 percent polypropylene; 10 to 35 percent elastomer; and 5 to 20 percent polyethylene. The elastomer may comprise at least one of (a) ethylene-hexene copolymer; (b) ethylene-butene copolymer; (c) ethylene-octene copolymer. The polyethylene may comprise a density of 0.94 g/cm3 to 0.97 g/cm3. The polyethylene may comprise an antioxidant and a lubricant. The antioxidant may comprise a compound of hindered phenolic antioxidant and phosphite antioxidant. The lubricant may comprise at least one of polyethylene wax and oxidized polyethylene wax. The polypropylene composition may comprise a homo-polypropylene with an isotactic index of 94 percent to 98 percent. An assembly of substrate 1 and insert 2 may be formed by placing a film 2 in a mold, closing the mold and injecting thermoplastic polypropylene material into the mold to form substrate 1 with film 2. The thermoplastic polypropylene material of substrate 1 may be injected into the mold at a temperature to melt film 2 in order to bond film 2 to substrate 1.

According to an exemplary embodiment as shown schematically in FIG. 3B, a side 11 of substrate 1 may be flush with a surface 21 of insert 2. A thickness of the trim component may be generally constant from a first section comprising substrate 1 and a second section comprising substrate 1 and insert 2.

According to an exemplary embodiment as shown schematically in FIG. 3C, substrate 1 may comprise a weakened portion 3 configured to direct deployment of an airbag. Insert 2 may comprise a weakened portion 3 configured to direct deployment of an airbag. Weakened portion 3 of insert 2 may extend from weakened portion 3 of substrate 1. Weakened portion 3 of insert 2 and weakened portion 3 of substrate 1 may be formed concurrently. Weakened portion 3 of insert 2 and weakened portion 3 of substrate 1 may be formed by at least one of a laser weakening process and a milling cutter weakening process.

According to an exemplary embodiment as shown schematically in FIG. 3D, the trim component may comprise a chute or airbag door 4 coupled to substrate 1 and insert 2. Chute or airbag door 4 may be attached to film 2 and substrate 1 to form the trim component. Chute 4 may be attached to film 2 and substrate 1 by welding chute 4 to film 2 and substrate 1. Insert 2 may be secured between chute 4 and substrate 1. Chute 4 may be welded to insert 2 and substrate 1. Chute 4 may be formed from a thermoplastic polyolefin material.

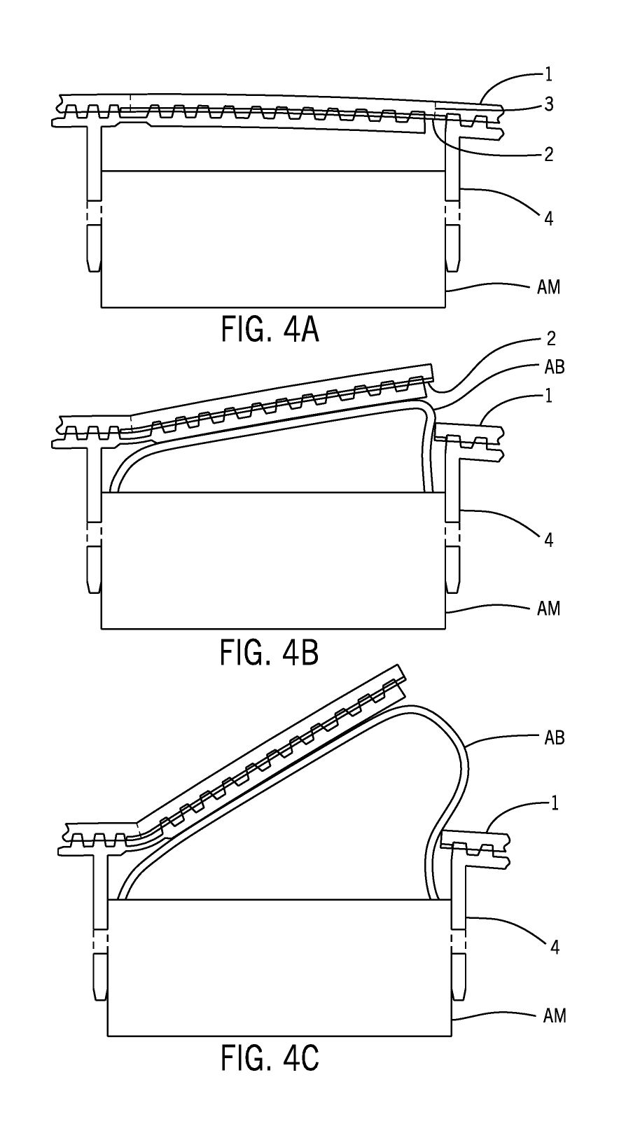

According to an exemplary embodiment as shown schematically in FIGS. 4A to 4C, the trim component may be configured to provide an opening for deployment of an airbag AB from an airbag module AM through the opening. Weakened portion 3 of insert 2 and weakened portion 3 of substrate 1 may provide the opening for deployment of airbag AB.

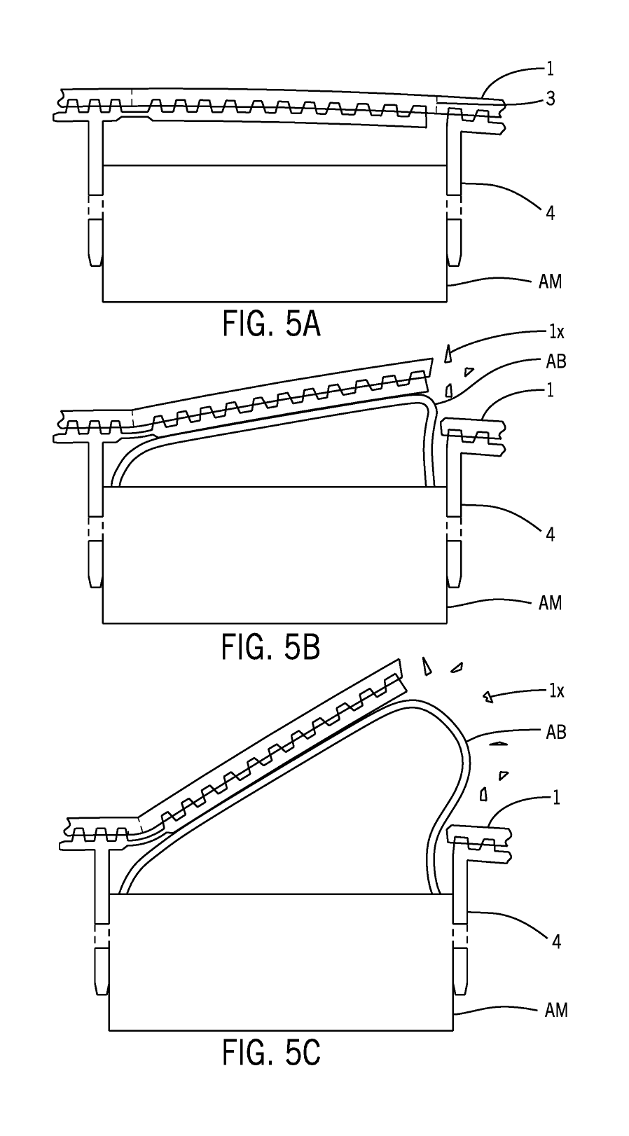

According to an exemplary embodiment as shown schematically in FIGS. 5A to 5C, a conventional trim component comprising a substrate 1 and a chute 4 and not comprising an insert may be configured to provide an opening for deployment of an airbag AB from an airbag module AM through the opening. A weakened portion 3 of substrate 1 may provide the opening for deployment of airbag AB. Portions 1x of substrate 1 may be formed upon deployment of airbag AB from airbag module AM and may separate from substrate 1.

### Exemplary Embodiment

As more attention is paid to the safety performance of automobiles, an airbag protection structure is arranged at the front passenger side on most instrument panels, wherein the area of instrument panel to arrange the airbag protection structure is referred to as an airbag door area, and the airbag door and the instrument panel are together referred to as an instrument panel assembly. A traditional airbag door is welded to the backside of the instrument panel at the airbag door area, so as to connect the airbag door and the instrument panel. When an accident occurs involving the automobile and the airbag is unfolded, there is a potential safety hazard for the instrument panel assembly connected only by welding: desoldering occurs to the airbag door and the instrument panel, the instrument panel is partially broken, and fragments are thrown out with the enormous external force due to airbag unfolding, causing harm to passengers.

To solve the above-mentioned problems, an intermediate medium may be added between the instrument panel body and the airbag door without affecting the welding. Since pre-cutting or pre-weakening for the instrument panel before welding process is required to ensure the instantaneous expansion of the airbag along the weakening trace of the instrument panel airbag door area when the airbag is unfolded, the intermediate medium between the instrument panel body and the airbag door is required to be pre-cut or pre-weakened before being inserted to the instrument panel body, and to be cut or weakened for the second time along the pre-cutting or pre-weakening line of the film after the instrument panel body and the film insert is integrally formed by injection molding so as to form on the instrument panel body the cutting lines or weakening lines aligned with the pre-cutting or pre-weakening lines on the film. However, it complicates the production process, and increases the productivity labor hour and the production cost of product.

To solve the above-mentioned problems of fragments thrown out due to desoldering and production cost increase due to secondary cutting, the invention is aimed to provide a method for forming an instrument panel assembly and the instrument panel assembly obtained therefrom.

The invention provides a method for forming an instrument panel assembly, comprising the following steps: S1, providing an instrument panel body mold with a movable mold and a stationary mold, and fixing a film formed with polypropylene composition on at least part of a partial surface of the movable mold covering an airbag door area of an instrument panel body; S2, closing the mold and injecting thermoplastic polypropylene material into the instrument panel body mold to melt the film with the temperature of the thermoplastic polypropylene material and fusing the polypropylene composition and the thermoplastic polypropylene material in a contacting area; S3, opening the mold to obtain the instrument panel body formed with thermoplastic polypropylene material, wherein the film is inserted into the backside of the instrument panel body to form an integral instrument panel with the instrument panel body; S4, weakening the airbag door area of the instrument panel, and forming flush airbag door weakening lines on the instrument panel body and the film at the same time by the weakening; S5, providing an airbag door formed with thermoplastic polyolefin material; and S6, welding the airbag door to the instrument panel body and at least part of the film, and fusing the polypropylene composition and the thermoplastic polyolefin material in the contacting area.

The film of the step S1 is not pre-cut or pre-weakened.

The polypropylene composition to form film in the step S1 comprises the following components by weight: 45 to 75 percent of polypropylene; 10 to 35 percent of elastomer; and 5 to 20 percent of polyethylene.

The polypropylene is a homo-polypropylene with an isotacticity index of 94%-98% and a melt flow rate of 1 g/10 min-5 g/10 min at 230° C. and under a load of 2.16 kg.

The elastomer is selected from: ethylene-hexene copolymer, ethylene-butene copolymer and ethylene-octene copolymer, with a density of 0.850 g/cm³-0.865 g/cm³ and a melt flow rate of 0.1 g/10 min-3 g/10 min at 190° C. and under a load of 2.16 kg.

The polyethylene is a high density polyethylene with a density of 0.94 g/cm³-0.97 g/cm³ and a melt flow rate of 0.01 g/10 min-0.5 g/10 min at 190° C. and under a load of 2.16 kg.

0.1 to 0.5 percent of antioxidant and 0.1 to 0.5 percent of lubricant by weight are also comprised based on the whole polypropylene composition.

The antioxidant is a compound of hindered phenolic antioxidant and phosphite antioxidant with a ratio of 1:1-2.

The lubricant is one of polyethylene wax and oxidized polyethylene wax or mixture of the two.

The thermoplastic polypropylene material to form instrument panel body in the step S2 is selected from: PP-EPDM-M20, PP-M20, PP-GF15, PP-GF30 and PP-MD25-GF15.

The weakening in the step S4 is performed with laser weakening process or milling cutter weakening process.

The welding in the step S6 is performed with vibration and friction welding, infrared welding or ultrasonic welding processes.

The invention also provides an instrument panel assembly comprising: an instrument panel body formed with thermoplastic polypropylene material; a film formed with a polypropylene composition, and an airbag door formed with thermoplastic polyolefin material, wherein the film is inserted into the backside of the instrument panel body in at least part of an area covering the airbag door to form an integral instrument panel with the instrument panel body, wherein the instrument panel body and the film are fused in a contacting area; wherein the airbag door is welded to the instrument panel body and at least part of the film, wherein the airbag door and the film are fused in the contacting area; and wherein the instrument panel body and the film have flush airbag door weakening lines formed at the same time in one weakening.

The film does not have a pre-cutting line or pre-weakening line.

The film may partially cover the weakening lines of the airbag door.

The film may fully cover the weakening lines of the airbag door.

The airbag door and the instrument panel may form a welding rib in welding process, and the film may partially cover the welding rib.

The film may fully cover the weakening lines of the welding rib.

The thickness of the film is between 0.01 mm and 1.00 mm.

Through fusing the film material, part of which is covering the airbag door area and inserted to the backside of the instrument panel body so as to form an integral instrument panel with the instrument panel body, and the airbag door material, the invention enhances the strength of the instrument panel assembly and restrains the fragments with the film when the instrument panel body is broken, so as to prevent harm to the passenger due to fragments thrown out caused by rapid unfolding of the airbag door and interference and collision of the structure of a windshield or an instrument panel, and to fulfill the safety requirements brought by the complex automobile instrument panel structure design.

The method for forming an instrument panel assembly provided by this invention comprises: providing an instrument panel body mold with a movable mold and a stationary mold with the movable mold side corresponding to the back side of the instrument panel body and the stationary mold side corresponding to the front side of the instrument panel body, and fixing a film to the cavity inner wall of the movable mold of the instrument panel body by manipulator as the film is not pre-cut or pre-weakened yet; closing the mold and injecting instrument panel body material to the instrument panel body mold to melt the film with melted instrument panel body material of high temperature in the mold cavity so as to ensure the film material and the instrument panel body material are fused in a contacting area and to maintain the film position stability since the film would not move with the injected plastic stream and instead would always be attached to the mold cavity wall due to its low flowability caused by the low melt index of the film material. The instrument panel body material may comprise thermoplastic polypropylene material, comprising but not limited to PP-EPDM-M20, PP-M20, PP-GF15, PP-GF30 and PP-MD25-GF15. PP-EPDM-M20 refers to a mixture of polypropylene, ethylene propylene diene monomer elastomer and inorganic mineral filling (the mass of the filling accounts for 20%). PP-M20 refers to a mixture of polypropylene and inorganic mineral filling (the mass of the filling accounts for 20%). PP-GF15 refers to a mixture of polypropylene and glass fiber filling (the mass of the filling accounts for 15%). PP-GF30 refers to a mixture of polypropylene and glass fiber filling (the mass of the filling accounts for 30%). PP-MD25-GF15 refers to a mixture of polypropylene, inorganic mineral filling (the mass of the filling accounts for 25%) and glass fiber filling (the mass of the filling accounts for 15%).

When the above-mentioned injection molding process is completed, the instrument panel is obtained by mold opening as shown in FIG. 1 and FIG. 2, and a film 2 is inserted to the backside of an instrument panel body 1 to form an integral instrument panel with instrument panel body 1 by injection molding. A backside 11 of instrument panel body 1 is flush with a surface 21 of film 2, such that the thickness of instrument panel 1 in an airbag door area is even after injection molding. Film 2 is not pre-cut or pre-weakened before injection molding.

Then, weakening is performed in the airbag door area of the instrument panel backside, i.e. forming flush airbag door weakening lines 3 on instrument panel body 1 and film 2 at the same time. Since the material of film 2 is a polypropylene compound which is similar to the thermoplastic polypropylene material of instrument panel 1, the material of film 1 and the material of instrument panel 1 are highly compatible; therefore, film 2 is not pre-cut or pre-weakened before being inserted into the instrument panel body mold, and can be weakened together with instrument panel body 1. Through such an instrument panel assembly production method, integral weakening of the instrument panel airbag door area is realized. The weakening process comprises but is not limited to laser weakening process and milling cutter weakening process. Moreover, film 2 is not pre-cut or pre-weakened before being inserted into the instrument panel body mold, and the position of film 2 can fully or partially cover the weakening lines of the airbag door area of instrument panel 1.

An airbag door 4 is welded to instrument panel body 1 and at least part of film 2. The welding process comprises but is not limited to vibration and friction welding, infrared welding and ultrasonic welding, etc., and the position selection of the film need not avoid a welding rib of the product. The material of film 2 and the material of airbag door 4 are fused in the contacting area. Airbag door 4 is a fixed-type airbag door or hooking-type airbag door. In such manner, the instrument panel assembly is formed.

The instrument panel assembly production method does not affect the injection molding, weakening, welding, surface spraying, surface flame treatment, surface foaming and surface coating processes in the production process of the instrument panel and the product appearance, etc. Through adding an extra film in the airbag door area of the instrument panel, the mechanical strength, the slow/high speed impact resistance after low temperature/normal temperature/high temperature/aging cycle and the welding strength of the instrument panel and the airbag door can be effectively improved, and the safety effect of the instrument panel in a head-on collision test and airbag deployment test can be improved; when the airbag door is unfolded and interference and collision occurs in the structure of windshield or instrument panel, it is ensured that the instrument panel is not broken or thrown out at the collision position, so that the safety requirements brought by the complex automobile instrument panel structure design is fulfilled and the safety of the passengers is more effectively ensured. Moreover, the film involved in this instrument panel assembly production method, with a thickness of between 0.01 mm and 1.00 mm, is at the backside of the airbag door area of the instrument panel, and does not affect the product appearance; it can fulfill the relevant production process requirements of the instrument panel, has good production flexibility, and can be widely applied in the production of hard/soft instrument panel and instrument panel with seamed/seamless airbag, wherein the applicable airbag door is of U-type, Y-type and H-type, etc.

The applicant has found that, if the ordinary film material [high density polyethylene (HDPE)/polyvinylchloride (PVC)/polyamide (PA)] is inserted in the movable mold and molded with the instrument panel body material by injection molding, ordinary film from the market can be easily peeled from or fall off the bonding surface of the instrument body, and detachment or bubble occurs between the contacting surfaces of the film and the instrument panel body, affecting the weakening process of the instrument panel body and weakening hole residual thickness stability of the instrument panel body; moreover, if ordinary film from the market is selected, the welding strength between the instrument panel and the airbag door and the welding pull-off force in the airbag door area of the instrument panel are decreased, desoldering easily occurs between the instrument panel and the airbag door during airbag deployment, and the instrument panel may be partially broken or thrown out with the enormous external force due to airbag unfolding, and there is a potential safety hazard. The film formed with polypropylene composition solves the above-mentioned problems.

Experimental results show that the preferred polypropylene composition comprises the following components by weight: 45 to 75 percent of polypropylene; 10 to 35 percent of elastomer; and 5 to 20 percent of polyethylene. The more preferred polypropylene composition comprises 0.1 to 0.5 percent of antioxidant and 0.1 to 0.5 percent of lubricant by weight. For the most preferred polypropylene composition, the half-peak width of the polypropylene crystallization peak is 5° C.-10° C., and the peak temperature of the polypropylene crystallization peak is preferred to be 105° C.-115° C.; the half-peak width of the crystallization peak and the peak temperature of the crystallization peak is obtained through tests following the standard ISO 11357 with a cooling rate of 10° C./min. The polypropylene is a homo-polypropylene with an isotacticity index of 94%-98% and a melt flow rate of 1 g/10 min-5 g/10 min at 230° C. and under a load of 2.16 kg; the elastomer is selected from: ethylene-hexene copolymer, ethylene-butene copolymer and ethylene-octene copolymer, with a density of 0.850 g/cm³-0.865 g/cm³ and a melt flow rate of 0.1 g/10 min-3 g/10 min at 190° C. and under a load of 2.16 kg; the polyethylene is a high density polyethylene with a density of 0.94 g/cm³-0.97 g/cm³ and a melt flow rate of 0.01 g/10 min-0.5 g/10 min at 190° C. and under a load of 2.16 kg; the antioxidant is a compound of hindered phenolic antioxidant and phosphate antioxidant with a ratio of 1:1-2; and the lubricant is one of polyethylene wax and oxidized polyethylene wax or mixture of the two. The above-mentioned components are produced as particles of raw material with twin screw extruding equipment, which leads to a good compatibility between the instrument body material and the airbag panel material; then, the particles of the raw material are produced as film with the cast extruding equipment or the calender equipment, and the film has features such as low thickness, low flowability, low vicat softening temperature, low melting point and good flexibility, elongation at break and low/high speed impact resistance, etc.; Examples of film raw material are shown below to describe the film material in detail, and not to limit.

Polypropylene 1: the isotacticity is 94%, MFR (230° C., 2.16 kg) is 1.0 g/10 min, the half-peak width the polypropylene crystallization peak is 5° C., and the peak temperature of the polypropylene crystallization peak is 110° C.

Polypropylene 2: the isotacticity is 95%, MFR (230° C., 2.16 kg) is 3.0 g/10 min, the half-peak width the polypropylene crystallization peak is 7.3° C., and the peak temperature of the polypropylene crystallization peak is 105° C.

Polypropylene 3: the isotacticity is 98%, MFR (230° C. 2.16 kg) is 5.0 g/10 min, the half-peak width the polypropylene crystallization peak is 10° C., and the peak temperature of the polypropylene crystallization peak is 108° C.

Ethylene-hexene copolymer: the density is 0.860 g/cm³ and MFR (190° C., 2.16 kg) is 0.5 g/10 min.

Ethylene-butene copolymer: the density is 0.865 g/cm³ and MFR (190° C., 2.16 kg) is 0.5 g/10min.

Ethylene-octene copolymer: the density is 0.855 g/cm³ and MFR (190° C., 2.16 kg) is 1.0 g/10 min.

High density polyethylene 1: the density is 0.94 g/cm³ and MFR (190° C., 2.16 kg) is 0.01 g/10 min.

High density polyethylene 2: the density is 0.95 g/cm³ and MFR (190° C., 2.16 kg) is 0.05 g/10 min.

High density polyethylene 3: the density is 0.97 g/cm³ and MFR (190° C., 2.16 kg) is 0.5 g/10 min.

Antioxidant: the antioxidant is a compound of hindered phenolic antioxidant and phosphite antioxidant 168 with a ratio of 1:1. The scientific name of the antioxidant 1010: tetra[β-(3,5-di-tert-butyl-4-hydroxyphenyl)propionate] pentaerythritol; the scientific name of the antioxidant 168: tris(2,4-di-tert-butyl) phenyl phosphite.

### Example 1

The components are weighed according to the weight percent shown in Table 1, and polypropylene, elastomer and high density polyethylene are mixed for 3 minutes in the high-speed mixer at first and then for 2 more minutes after the antioxidant and the lubricant are added with a rotation speed of 2000 r/min so as to obtain the premix; the premix is melted and extruded by a twin screw extruder with the screw temperature of each zone maintained within 190-230° C., and is produced as a polypropylene composition with good low-temperature toughness by vacuum granulation; the corresponding test strips are produced according the standards, and the mechanical performance and the gloss are measured. The specific values are listed in Table 2, while the test standards are listed in Table 3.

TABLE 1
Composition of Film Material

| | Number | | | |
|---|---|---|---|---|
| | Embodiment (percent by weight) | | | |
| Material | 1 | 2 | 3 | 4 |
| Polypropylene 1 | 74.6 | — | — | — |
| Polypropylene 2 | — | 56.3 | — | — |
| Polypropylene 3 | — | — | 45.2 | 54.1 |
| Ethylene-hexene copolymer | 20 | — | — | 10 |
| Ethylene-butene copolymer | — | — | 35 | 15 |
| Ethylene-octene copolymer | — | 25 | — | — |
| High density polyethylene 1 | 5 | — | — | — |
| High density polyethylene 2 | — | 18 | — | 20 |
| High density polyethylene 3 | — | — | 19 | — |
| Antioxidant | 0.2 | 0.3 | 0.4 | 0.4 |
| Polyethylene wax | 0.2 | 0.4 | 0.4 | 0.2 |
| Oxidized polyethylene wax | — | — | — | 0.3 |

TABLE 2
Performance of Film Material

| | Number Inspection Items | | | |
|---|---|---|---|---|
| | 1 | 2 | 3 | 4 |
| Density (g/cm³) | 0.903 | 0.906 | 0.91 | 0.911 |
| Melt Index (g/10 min) | 0.83 | 2.68 | 3.21 | 3.1 |
| Tensile Strength (Mpa) | 18.6 | 18.4 | 17.9 | 18.8 |
| Elongation at Break (%) | 320 | 347 | 415 | 380 |
| Bending Strength (Mpa) | 17.2 | 15.5 | 14.5 | 15 |
| Bending Modulus (Mpa) | 730 | 567 | 496 | 550 |
| Notched Izod Impact | 56.8 | 68.5 | 75.3 | 63.4 |
| Strength (23° C.) (kJ/m²) | | | | |
| Notched Izod Impact | 48.3 | 61.5 | 66.9 | 58.4 |
| Strength (−30° C.) (kJ/m²) | | | | |
| Glossness (60°) | 42.1 | 36.7 | 32.4 | 37.2 |

TABLE 3
Testing Standards of Film Material

| Testing Items | Units | Testing Standards |
|---|---|---|
| Melt Flow Rate | g/10 min | ISO 1133 |
| Density | g/cm³ | ISO 1183 |
| Tensile Strength | MPa | ISO 527-1, 527-2 |
| Elongation at Break | % | ISO 527-1, 527-2 |
| Bending Strength | MPa | ISO 178 |
| Bending Modulus | MPa | ISO 178 |
| Notched Izod Impact Strength (23° C.) | kJ/m² | ISO 180 |
| Notched Izod Impact Strength (−30° C.) | kJ/m² | ISO 180 |
| Glossness (60°) | | ASTM D523 |

It should understood that the film is incorporated into the backside of the instrument panel body by insert molding; depending on actual demand, the incorporation area can be the whole airbag door area of the instrument panel, partial weakening line area of the airbag door near the passenger side, or partial hinge weakening line area of the airbag door near the windshield side, etc.; the shape of the inserted film can be an integral piece of film, or the film can be partially cut-out to insert into the backside of the instrument panel body; also, the film can be divided into two or more pieces so as to insert into the backside of the instrument panel body.

The instrument panel assembly formed with the above-mentioned method of this invention comprises: an instrument panel body 1 formed with thermoplastic polypropylene material; film 2 formed with polypropylene composition, which is inserted into the backside of the instrument panel body 1 in at least part of the area covering airbag door to form an integral instrument panel with the instrument panel body 1, wherein the instrument panel body 1 and the film 2 are fused in the contacting area; and an airbag door 4 formed with thermoplastic polyolefin material, which is welded to the instrument panel body 1 and at least part of the film 2, wherein the airbag door 4 and the film 2 are fused in the contacting area; wherein, the instrument panel body 1 and the film 2 have flush airbag door weakening lines 3 formed at the same time in one weakening. The film 2 does not have a pre-cutting line or pre-weakening line. The film covers the weakening lines of the airbag door partially. The film covers the weakening lines of the airbag door fully. The airbag door and the instrument panel form a welding rib in welding process, and the film may partially cover the welding rib. The film may fully cover the welding rib. The thickness of the film is between 0.01 mm and 1.00 mm.

With the method for forming an instrument panel assembly, the film is between the instrument panel and the airbag door, and serves as a bridge if there is a welding rib, increasing the welding strength of the instrument panel and the airbag door and ensuring the stability of the airbag door area welding strength; if there is no welding rib, due to its good flexibility, elongation at break and low/high speed impact resistance, etc., the film covers the backside of the instrument panel well, and forms a good malleable layer on the instrument panel backside. The integral impact resistance of the airbag door area is improved; the partial breaking of the instrument panel and fragment thrown out due to collision after airbag unfolding is prevented; the design requirements of complex automobile instrument panel structure are fulfilled in a better way, the complex production process requirements of instrument panel are fulfilled at the same time, and the safety of the instrument panel is enhanced.

The above-mentioned are merely the preferred embodiments of the invention. The invention scope is not so limited and many variations may be made to the above-mentioned embodiments of the invention. All the simple modifications, changes and embellishments of the above-mentioned embodiments according to the claims and description of the invention shall fall within the protection scope of the invention. The content that has not been described in detail is about conventional techniques.

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

What is claimed is:

1. A trim component for a vehicle interior configured to provide an opening for deployment of an airbag through the opening comprising:
a substrate comprising a weakened portion configured to direct deployment of the airbag;
an insert coupled to the substrate comprising a weakened portion configured to direct deployment of the airbag; and
a chute coupled to the substrate and the insert,
wherein the insert comprises a film comprising a polypropylene composition; and
wherein the film is secured between the chute and the substrate.

2. The trim component of claim 1 wherein the film is bonded to the substrate.

3. The trim component of claim 1 wherein the chute is welded to the film and the substrate.

4. The trim component of claim 1 wherein the weakened portion of the insert extends from the weakened portion of the substrate.

5. The trim component of claim 1 wherein the substrate is formed from a thermoplastic polypropylene material.

6. The trim component of claim 1 wherein the polypropylene composition comprises polypropylene; an elastomer; and polyethylene.

7. The trim component of claim 1 wherein the chute is formed from a thermoplastic polyolefin material.

8. The trim component of claim 1 wherein the weakened portion of the insert and the weakened portion of the substrate are formed concurrently.

9. The trim component of claim 1 wherein the film comprises a thickness of less than 1.0 mm.

10. A trim component for a vehicle interior configured to provide an opening for deployment of an airbag through the opening prepared by a process comprising the steps of:
placing a film in the mold;
closing the mold;
injecting thermoplastic polypropylene material into the mold to form a substrate with the film;
opening the mold and removing the substrate with the film;
weakening the substrate and the film to define an airbag door opening; and
attaching a chute to the film and the substrate to form the trim component.

11. A method for forming a trim component in a mold comprising the following steps:
placing a film in the mold;
closing the mold;
injecting thermoplastic polypropylene material into the mold to form a substrate with the film;
opening the mold and removing the substrate with the film;
weakening the substrate and the film to define an airbag door opening; and
attaching a chute to the film and the substrate to form the trim component.

12. The method of claim 11 wherein the thermoplastic polypropylene material is injected into the mold at a temperature to melt the film in order to bond the film to the substrate.

13. The method of claim 11 wherein attaching the chute to the film and the substrate comprises welding the chute to the film and the substrate.

14. The method of claim 11 wherein the film is formed from a polypropylene composition.

15. The method of claim 14 wherein the polypropylene composition comprises polypropylene; an elastomer; and polyethylene.

16. The method of claim 15 wherein the elastomer comprises at least one of (a) ethylene-hexene copolymer; (b) ethylene-butene copolymer; (c) ethylene-octene copolymer.

17. The method of claim 15 wherein the polyethylene comprises a density of 0.94 g/cm3 to 0.97 g/cm3.

18. The method of claim 15 wherein the polyethylene comprises an antioxidant and a lubricant; wherein the antioxidant comprises a compound of hindered phenolic antioxidant and phosphite antioxidant; and wherein the lubricant comprises at least one of polyethylene wax and oxidized polyethylene wax.

19. The method of claim 14 wherein the polypropylene composition comprises 45 to 75 percent polypropylene; 10 to 35 percent elastomer; and 5 to 20 percent polyethylene.

20. The method of claim 14 wherein the polypropylene composition comprises a homo-polypropylene with an isotactic index of 94 percent to 98 percent.
